(19) United States
(12) Patent Application Publication
(10) Pub. No.: US 2013/0306719 A1
(43) Pub. Date: Nov. 21, 2013

(54) PAPER STRUCTURE AND CARTON BOX THEREOF

(71) Applicant: MING-CHUAN CHOU, New Taipei City (TW)

(72) Inventor: MING-CHUAN CHOU, New Taipei City (TW)

(73) Assignees: MING-CHUAN CHOU, New Taipei City (TW); TSAE SHENG INTERNATIONAL CO., LTD., New Taipei City (TW)

(21) Appl. No.: 13/655,565

(22) Filed: Oct. 19, 2012

(30) Foreign Application Priority Data
May 18, 2012 (TW) 101209456

(51) Int. Cl. B65D 17/00; B32B 3/30

(52) U.S. Cl. 229/246; 428/165

(57) ABSTRACT

A paper structure is disclosed, which comprises: a paper substrate; an adhesive layer, formed on the paper substrate; and a polymer layer; wherein the polymer layer is configured with a plurality of embossed elements and is disposed on the adhesive layer for allowing the spaces formed between the embossed structures and the paper substrate to be filled by the adhesive layer. In addition, the flexibility of a carton box that is formed using the aforesaid paper structure can be enhanced through the cooperation between the embossed structures and the adhesive layer filled inside the recesses of the embossed structures, and thus the ability of the carton box to absorb collision impact can be improved.

### FIELD OF THE INVENTION

The present invention relates to a paper material, and more particularly, to a paper structure with three-dimensional strengthening elements and the carton box formed by using such paper structure.

### BACKGROUND OF THE INVENTION

Conventionally, in most carton boxes that are used for packaging, there are buffer members disposed therein so as to be used for fixedly securing items inside the carton boxes without wobbling. It is noted that most such buffer members are made of either polyfoam or other foam materials. Nevertheless, although the buffer member made of foam materials are advantageous in its light weight and low cost, such foam materials can be a threat to our environment since they do not decompose by any natural degradation process and will maintain its shape for thousands of years while burying in landfill unless physically broken. On the other hand, even enabling those waste foam materials to be processed by incineration, not only there will be toxic pollutants being produced by the incineration process that will threaten the health and quality of life of millions of people, there will be additional waste management cost needed for processing those toxic pollutants.

There are already many studies focusing on solving the aforesaid problems. One of which is a carton box disclosed in TW Pat. Pub. No. 227213, which is substantially an outer box having an inner box fitted therein and the inner box is formed with holes of different shapes at its top panel that are provided for items to inserted therein so as to be fixedly secured and packaged inside the outbox.

In those prior arts, despite the paper materials used for making those conventional carton boxes are environmental friendly and is equipped with shock absorption ability, the durability of those paper materials are generally questionable and thus the resulting carton boxes may maintain to be usable for only a short period of time. Consequently, the production of such carton boxes can be considered as a huge waste in paper resources. Moreover, on the faces of most conventional paper materials that are used for making carton boxes for packaging, there are generally two-dimensional patterns formed thereon by screen printing that can not achieve any stereoscopic 3D effect.

Therefore, it is in need of a paper structure and the carton box thereof designed for overcoming the aforesaid shortcomings.

### SUMMARY OF THE INVENTION

In view of the disadvantages of prior art, the primary object of the present invention is to provide a paper structure having a plurality of embossed elements arranged at positions corresponding to patterns, characters, or colors formed on a surface of a paper substrate of the paper structure, whereby the paper structure can generate a three-dimensional visual effect for achieving a decorative purpose. In addition, by the forming of the plural embossed elements on the paper structure, the flexibility of the aforesaid paper structure can be enhanced, and thus the strength and durability of the paper structure can be improved, and consequently the waste in paper resource is reduced.

Another object of the invention is to provide a carton box, having at least one side thereof to be made from a paper structure with embossed elements. As the strength of the paper structure is enhanced by the embossed elements formed thereon, the carton box can be made from thinner cardboards but still maintains the same strength as other carton boxes of thicker cardboards. In addition, the flexibility of the aforesaid paper structure can be enhanced by the embossed structures, and thereby the ability of the carton box to absorb collision impact can be improved so that there can be less buffer materials required in the carton box and also the thickness of the buffer materials can be reduced.

In an embodiment, the present invention provides a paper structure, comprising: a paper substrate; an adhesive layer, formed on the paper substrate, and a polymer layer, formed on the adhesive layer; wherein the polymer layer is configured with a plurality of embossed elements; and the adhesive layer is arranged filling the spaces formed between the embossed structures and the paper substrate.

In another embodiment, the present invention provides a carton box, comprising: a box having at least one side thereof to be made from a paper structure; wherein the paper structure is comprised of: a paper substrate; an adhesive layer, formed on the paper substrate; and a polymer layer, formed on the adhesive layer; and the polymer layer is configured with a plurality of embossed elements; and the adhesive layer is arranged filling the spaces formed between the embossed structures and the paper substrate.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a sectional view of a paper structure according to an embodiment of the present invention.

FIG. 1B is a schematic diagram showing the embossed elements of the present invention.

FIG. 2A and FIG. 2B are a top view and a sectional view of a paper structure according to another embodiment of the present invention.

FIG. 3A to FIG. 3C are schematic diagrams showing a carton box that is made from a paper structure according to an embodiment of the invention.

FIG. 4 is a schematic diagram showing a carton box according another embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

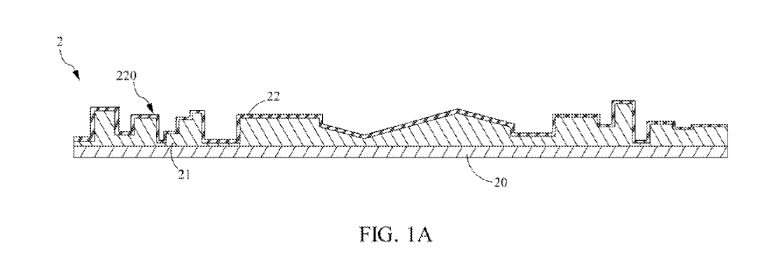

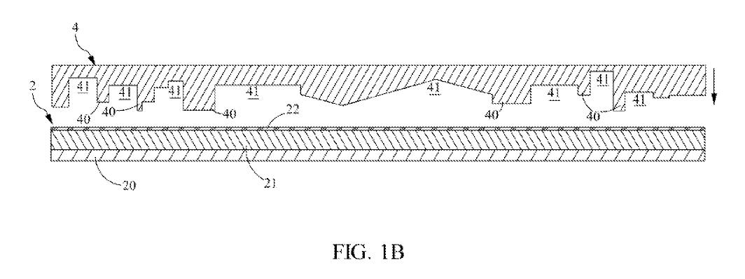

Please refer to FIG. 1A, which is a sectional view of a paper structure according to an embodiment of the present invention. As shown in FIG. 1A, the paper structure 2 can be a roll of paper or a sheet of paper, whichever can be wrapped around the periphery of an item or can be made into a box for items to be received therein. In this embodiment, the paper structure 2 comprises: a paper substrate 20, an adhesive layer 21 and a polymer layer 22. Moreover, the paper substrate 20 can substantially be an artificial synthetic paper, such as synthetic papers made from stone or plastic materials, synthetic papers made from natural pulp, or synthetic papers made from recycle papers. In addition, the paper substrate 20 can be a paper adapted for printing. The adhesive layer 21 is formed on the paper substrate 20 and is made of a hot melt adhesive whichever has good flowability when heated, and can become harden with sufficient flexibility after cooling down. In an embodiment of the invention, the adhesive layer is made of an ethylene vinyl acetate (EVA) hot melt adhesive, but is not limited thereby.

The polymer layer 22 is configured with a plurality of embossed elements 220 and is formed on the adhesive layer 21 for allowing the spaces formed between the plural embossed structures 220 and the paper substrate 20 to be filled by the adhesive layer 21. The polymer layer 22 is used as a protective layer for preventing the paper substrate 20 and the adhesive layer 21 from being damaged by friction or collision impact. The polymer layer 22 is made of material selected from the group consisting of: oriented polypropylene (OPP) and polyethylene terephthalate (PET). In this embodiment, the polymer layer 22 is made of PET. Please refer to FIG. 1B, which is a schematic diagram showing the embossed elements of the present invention. As shown in FIG. 1B, the embossed elements 220 is formed on the polymer layer 22 by hot pressing a mold 4 on the polymer layer 22. That is, when the heated mold 4 is pressed upon the polymer layer 22, the heat from the mold 4 is conducted to the adhesive layer 21 for enabling the adhesive layer 21 to be heated and become flowable, and simultaneously as the polymer layer 22 is being pressed by the mold 4, the adhesives of the adhesive layer that are located at positions corresponding to the projections 40 of the mold 4 will be pressed and forced to flow toward the positions corresponding to the concaves 41 of the mold 4. Thereby, the polymer layer 22 can be embossed and attached tightly against each and every projections 40 and concaves 41 of the mold 4, so that after the mold 4 is removed and the adhesive layer 21 is cooled and hardened, the polymer layer 22 configured with a plurality of embossed elements 220 can be achieved, as shown in FIG. 1A. Comparing to prior arts, the paper structure 2 of the invention can be configured with the plural embossed elements 220 without having its paper substrate to be pressed and deformed by external forces, and thus the paper substrate 20 of the invention is smooth and flat. It is noted that the paper substrate 20, the adhesive layer 21 and the polymer layer 22 can each be made of a thickness as required without any restriction.

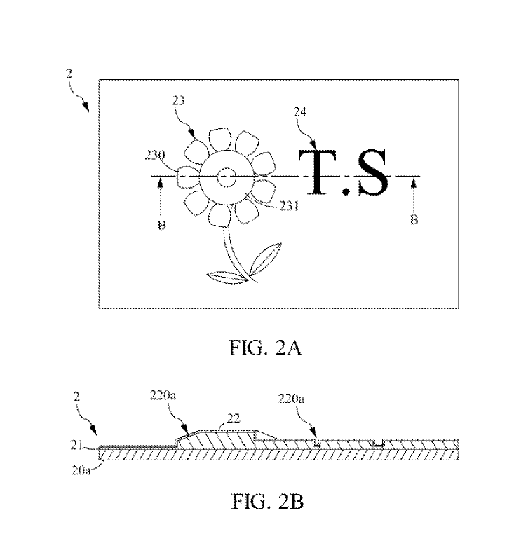

Please refer to FIG. 2A and FIG. 2B, which are a top view and a sectional view of a paper structure according to another embodiment of the present invention. In FIG. 2A, the paper structure 2 is a wrapping paper adapted for wrapping an item for achieving an aesthetic purpose. In this embodiment, the paper structure 2 similarly comprises: a paper substrate 20a, an adhesive layer 21a and a polymer layer 22a. In addition, there are patterns or characters to be formed on a surface of the paper substrate 20a that is arranged corresponding to the adhesive layer 21a, and alternatively, there can be colors to be formed on a surface of the paper substrate 20a in addition to the patterns or characters. It is noted that the paper substrate 20a is made of the same material as described in the previous embodiment of FIG. 1A, and thus will not be described further herein, which is also true for the adhesive layer 21a and the polymer layer 22a as well.

As shown in FIG. 1A, there are a flower pattern 23 and two characters 24, i.e. “T” and “S”, that are formed on the paper substrate 20a. Correspondingly from the cross section shown in FIG. 2B, the pattern 23 or the characters are constructed from the assembly of the projected portions of the plural embossed elements 220a. In this embodiment, the flower petal 230 and the flower pistil 231 are located corresponding to the projections of the adhesive layer 21 and the polymer layer 22, while the characters 24 are formed at positions corresponding to the concaves of the adhesive layer 21 and the polymer layer 22. By having the plural embossed elements 220a combined with corresponding colors, patterns or characters for forming a three-dimensional visual effect, the aesthetics of the paper structure 2 is enhanced by a 3D stereoscopic and tactile decorative effect. In another embodiment of the invention, a part of the plural embossed elements can be formed as an anti-counterfeiting element. Moreover, in further another embodiment of the invention, the part of embossed elements that are assembled into the anti-counterfeiting element can also be used as product identity or corporate identity. Thereby, not only the pattern of product identity or corporate identity can be used for anti-counterfeiting, but also it is created with 3D stereoscopic and tactile decorative effect.

It is noted that the patterns or characters can be projected or concaved at will according user requirements, and thus are not limited by the embodiments of the invention. Moreover, as the structural integrity of the paper structure is enhanced by the embossed elements and also the flexibility of the paper structure can be enhanced by the adhesive layer sandwiched between the embossed structures and the paper substrate, the ability of the paper structure to absorb collision impact can be improved so that the patterns, characters and colors on the paper substrate can be well protected and thus the life span of the paper structure is prolonged. In addition, since there can be patterns, characters, and colors formed on the surface of the paper substrate 20 in the paper structure 2, such paper structure 2 can be used as a decorative paper attached upon a wrapping paper, a poster, a painting or a calendar.

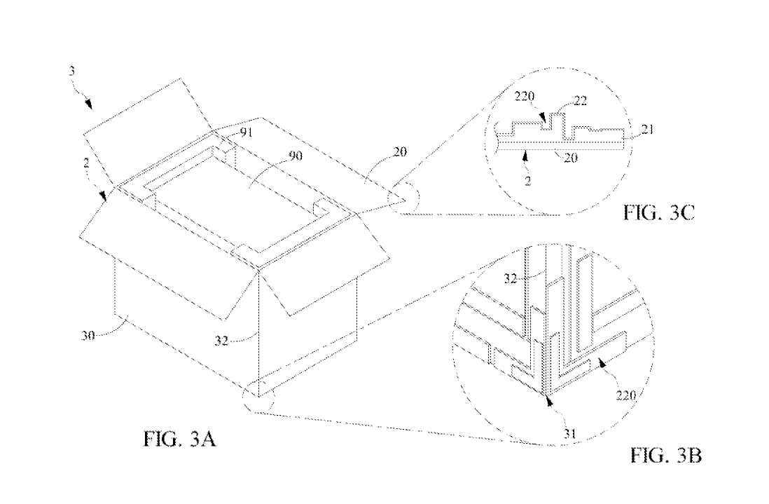

Please refer to FIG. 3A to FIG. 3C, which are schematic diagrams showing a carton box that is made from a paper structure according to an embodiment of the invention. In this embodiment, a carton box 3 includes a box body 30 that is formed by the bending of a paper structure 2, whereas the paper structure 2 comprises a paper substrate 20, an adhesive layer 21 and a polymer layer 22 that are constructed the same as the aforesaid embodiments. It is noted that the box body 30 is formed with an accommodation space for allowing an item 90 to be received therein. Generally, there are buffer materials 91 to be arranged surrounding the periphery of the item 91, whereas the buffer materials 90 can be made of polyfoam or foam materials and be used for absorbing collision impact and thus preventing the item 90 from being damaged. As the embodiment shown in FIG. 3A, at the positions of the paper structure 2 that are to be bended into bends 32, the portions of the adhesive layer and the polymer layer that are arranged corresponding to those bends 32 can be produced thinner than other portions or even in some case, there can be no adhesive layer and the polymer layer to be formed at those bends 32. Thereby, it is easier to bend the paper structure 2 into the box 32. Nevertheless, the arrangement of the adhesive layer and the polymer layer in the paper structure is not limited to this embodiment and thus there can still be the adhesive layer and the polymer layer of normal thicknesses being arranged at those bends 32, but their arrangements are determined according to their respective materials in the making. It is noted that the carton box is not limited to be a box for packaging, and it can be a decorative case for an electronic apparatus, such as a protective case for cellular phones.

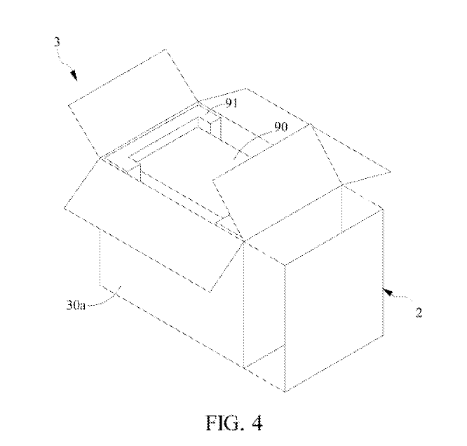

Considering that it is possible for the carton box to be hit or impacted during transportation, consequently there can be a plurality of embossed elements 220 to be formed on corners 31 of the box and also on all the sides for constructing the corner 31, as shown in FIG. 3B. Thereby, the structural integrity of the carton box 3 can be strengthened. In addition, the plural embossed elements 220 that are arranged at the corner 31 of the carton box 3 can be formed into various shapes according to actual requirements, by that not only the structural integrity of the carton box 3 is strengthened, but also the aesthetic of the carton box 3 is improved. As shown in FIG. 3B, the corner 31 is the joint of three sides, but it is not limited thereby and it can be a bend jointed by two sides. As shown in FIG. 3C, there is an adhesive layer 21 sandwiched between the paper substrate 20 and the polymer layer 22 with embossed elements 220, by that the adhesive layer can help to absorb collision impact so as to further prevent any item inside the carton box 3 from damaged by impact. It is noted that the amount of the embossed element 220 as well as their positions can be determined according to actual requirements, and generally the embossed elements 220 are densely distributed at positions corresponding to the most vulnerable positions of the items that are to be received inside the carton box 3, or at positions on the carton box 3 where it is most likely to be hit during transportation. Please refer to FIG. 4, which is a schematic diagram showing a carton box according another embodiment of the invention. In the embodiment shown in FIG. 4, the box body 30a of the carton box 3 can be made from wood, plastic, or other materials that are not the paper structure 2 described in previous embodiments, and the structural integrity of such box body 30a can still be strengthened simply by adhering the paper structure 2 on at least one side of the box body 30a, and more particularly, on a bend jointed by two sides of the box body 30a or corner of the box body 30a.

To sum up, as the structural integrity and strength of the paper structure is enhanced by the embossed elements and also the flexibility of the paper structure can be enhanced by the adhesive layer sandwiched between the embossed structures and the paper substrate, the ability of the paper structure to absorb collision impact and friction can be improved. In addition, as the strength of the paper structure is enhanced by the embossed elements formed thereon, the carton box can be made from thinner cardboards but still maintains the same strength as other carton boxes of thicker cardboards. In addition, the flexibility of the aforesaid paper structure can be enhanced by the embossed structures, and thereby the ability of the carton box to absorb collision impact can be improved so that there can be less buffer materials required in the carton box and also the thickness of the buffer materials can be reduced. Consequently the waste in paper resource is reduced. Comparing to the conventional carton boxes, the carton box of the present invention, that are made from the paper structure of the same thickness as those conventional carton boxed, is clearly being built with better burst strength and compression strength as well, so that the durability of the carton box of the present invention is much better than those conventional carton boxes and can sustain more repetitive usages. In addition, since the paper structure of the invention is flexible for absorbing collision impact, the use of polyfoam or foam materials can be reduced. As the paper structure of the invention is configured with the embossed elements for strength improvement and the adhesive layer for flexibility enhancement, the durability of the paper structure is improved. Consequently, the production of such carton boxes can be considered as a big save in paper resources.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A paper structure, comprising:
a paper substrate;
an adhesive layer, formed on the paper substrate; and
a polymer layer, formed on the adhesive layer, and configured with a plurality of embossed elements;
wherein, the adhesive layer is arranged to fill spaces formed between the plurality of embossed structures and the paper substrate.

2. The paper structure of claim 1, wherein the polymer layer is made of material selected from the group consisting of: oriented polypropylene (OPP) and polyethylene terephthalate (PET).

3. The paper structure of claim 1, wherein there are patterns or characters to be formed on a surface of the paper substrate that is arranged corresponding to the adhesive layer.

4. The paper structure of claim 3, wherein the plurality of embossed elements have projected portions that are formed at positions corresponding to the patterns or the characters.

5. The paper structure of claim 1, wherein there are colors to be formed on a surface of the paper substrate that is arranged corresponding to the adhesive layer.

6. The paper structure of claim 1, wherein the adhesive layer is made of an ethylene vinyl acetate (EVA) hot melt adhesive.

7. The paper structure of claim 1, wherein a part of the plurality of embossed elements is formed as an anti-counterfeiting element.

8. The paper structure of claim 7, wherein there are patterns or characters that are created for product identity or corporate identity to be formed on a surface of the anti-counterfeiting element.

9. A carton box, comprising:
a box body, having at least a side thereof to be made from a paper structure;
wherein, the paper structure further comprising:
a paper substrate;
an adhesive layer, formed on the paper substrate; and
a polymer layer, configured with a plurality of embossed elements and being formed on the adhesive layer for allowing spaces formed between the plurality of embossed structures and the paper substrate to be filled by the adhesive layer.

10. The carton box of claim 9, wherein the polymer layer is made of material selected from the group consisting of: oriented polypropylene (OPP) and polyethylene terephthalate (PET); and the adhesive layer is made of an ethylene vinyl acetate (EVA) hot melt adhesive.

11. The carton box of claim 9, wherein there are patterns or characters formed on a surface of the paper substrate that is arranged corresponding to the adhesive layer.

12. The carton box of claim 11, wherein the plurality of embossed elements have projected portions that are formed at positions corresponding to the patterns or the characters.

13. The carton box of claim 9, wherein there are colors to be formed on a surface of the paper substrate that is arranged corresponding to the adhesive layer.

14. The carton box of claim 9, further comprising:
at least one buffer material, arranged inside the carton box to be used for attaching to the periphery of an item to be received inside the carton box.

15. The carton box of claim 9, wherein there is a corner of the box body which has each of its sides to be formed from the paper structure.

16. The carton box of claim 15, wherein each side of the corner is formed with the embossed elements so as to strengthened the structural integrity of the box body.

17. The carton box of claim 9, wherein the box body is substantially formed by the bending of the paper structure.

18. The carton box of claim 9, wherein the paper structure is glued to the box body.

19. The carton box of claim 9, wherein a part of the plurality of embossed elements is formed as an anti-counterfeiting element.

20. The carton box of claim 19, wherein there are patterns or characters that are created for product identity or corporate identity to be formed on the anti-counterfeiting element.
